(19) United States
(12) Patent Application Publication
(10) Pub. No.: US 2002/0073676 A1
(43) Pub. Date: Jun. 20, 2002

(54) Net shaker rotation control system and method

(75) Inventors: Franklin P. Orlando, Morgan Hill, CA (US); Marty Dean Youman, Madera, CA (US)

Correspondence Address: Henry M. Stanley, 165 East Hilton Drive, Boulder Creek, CA, 95006, US

(73) Assignee: Ag-Right Enterprises

(21) Appl. No.: 09/741,366

(22) Filed: Dec. 19, 2000

(51) Int. Cl. A01D 46/00

(52) U.S. Cl. 56/340.1

(57) ABSTRACT

A net rotation speed control system for an oscillatory shaker head assembly driven by a force-balance drive carried on a crop harvester has a harvester forward velocity signal input. Also provided is an operator input for selecting appropriate speed relationship between the harvester velocity and the net shaker head rotation velocity. The system is useful as an open loop system, but is improved to correct for otherwise uncontrolled operating conditions by incorporating a speed sensor for net shaker head rotation velocity and closing the loop by connecting an output from the net rotation speed sensor to the control system.

### SUMMARY OF THE INVENTION

The invention disclosed herein relates to an apparatus for controlling net rotation speed of an oscillating shaker head produced by an oscillatory driver operating to drive the shaker head about an oscillation axis for contacting foliage of vines, bushes and trees to dislodge crops therefrom. The oscillating shaker head is mounted on a mobile vehicle for moving at a controlled speed past and proximate to the foliage. The apparatus includes means for sensing the controlled speed of the mobile vehicle, wherein the means for sensing provides a vehicle speed proportional signal. Also included is means for receiving the vehicle speed proportional signal and for providing a shaker head control signal related to vehicle speed. Further, means is provided for receiving the shaker head control signal and for providing a predetermined control torque about the oscillation axis of the shaker head so that net rotation speed of the oscillating shaker head is controlled relative to the speed of the mobile vehicle.

The invention disclosed herein also relates to an apparatus for controlling net rotation speed of an oscillating shaker head produced by an oscillatory driver operating to drive the shaker head about an oscillation axis for contacting foliage of vines, bushes and trees to dislodge crops therefrom. The oscillating shaker head is mounted on a mobile vehicle for moving at a controlled speed past and proximate to the foliage. The apparatus includes means for sensing the controlled speed of the mobile vehicle, wherein the means for sensing provides a vehicle speed proportional signal. Also included is means for receiving the vehicle speed proportional signal and for providing a braking signal related to vehicle speed. Further, means is provided for receiving the braking signal and for providing braking resistance about the oscillation axis of the shaker head so that net rotation speed of the oscillating shaker head is controlled relative to the speed of the mobile vehicle.

In another aspect of the invention a harvesting vehicle moves over an underlying surface at a controlled speed and carries a force balance crop shaker head having a drive mechanism connected to drive a shaker drum assembly in an oscillatory manner about a rotation axis. The drive mechanism operates to drive the shaker drum assembly to produce a net shaker drum rotation speed. The shaker drum assembly operates to engage foliage on a crop for dislodging the crop therefrom. A speed sensor on the harvesting vehicle is provided for sensing the controlled speed and for providing a vehicle speed indicative signal. Means is also provided for generating an operator control signal and control means is present for receiving the vehicle speed indicative signal and the operator control signal and for providing a braking signal output corresponding to the received signals. Means receives the braking signal for providing an operator controlled braking action for the shaker drum assembly rotation about the rotation axis. In this manner, net shaker drum rotation speed is operator controlled relative to the harvesting vehicle controlled speed.

The invention further includes a method for controlling net rotation speed of an oscillating shaker head in a crop harvester for dislodging crops from crop foliage, wherein the net rotation speed is produced about an oscillation axis by an oscillatory driving mechanism for the shaker head. The harvester is moved at a controlled speed past and proximate to the crop foliage. The method includes the steps of sensing the speed of the crop harvester and providing a vehicle speed indicative signal corresponding thereto. A further step relates to conversion of the vehicle speed indicative signal into a corresponding shaker head control signal. Subsequently, torque is applied about the oscillation axis corresponding to the shaker head control signal, so that net rotation speed of the oscillating shaker head is controlled relative to the harvester controlled speed.

The invention further includes a method for controlling net rotation speed of an oscillating shaker head in a crop harvester for dislodging crops from crop foliage, wherein the net rotation speed is produced about an oscillation axis by an oscillatory driving mechanism for the shaker head. The harvester is moved at a controlled speed past and proximate to the crop foliage. The method includes the steps of sensing the speed of the crop harvester and providing a vehicle speed indicative signal corresponding thereto. A further step relates to conversion of the vehicle speed indicative signal into a corresponding braking signal. Subsequently, braking action is applied about the oscillation axis corresponding to the braking signal, so that net rotation speed of the oscillating shaker head is controlled relative to the harvester controlled speed.

### BRIEF DESCRIPTION OF THE DRAWINGS

FIG. 1 is a schematic depiction of one embodiment of the system of the present invention.

FIG. 2 is a block diagram of another embodiment of the present invention.

FIG. 2A shows a variation from the embodiment of FIG. 2.

FIG. 3 is a block diagram of an additional embodiment of the present invention.

FIG. 3A is a detail from the embodiment of FIG. 3.

FIG. 3B shows a variation from the embodiment of FIG. 3A.

FIG. 4A is a flow diagram showing the method of the present invention.

FIG. 4B is a flow diagram showing a variation of the method of the present invention.

FIG. 5 is a partial view illustrating one set of operating conditions in which the invention functions.

FIG. 6 is a partial view illustrating another set of operating conditions in which the invention functions.

### DESCRIPTION OF THE PREFERRED EMBODIMENTS

Force balance type shakers having tines for extending into and engaging the foliage of vines, bushes and trees to dislodge a crop therefrom are typified by the harvesting shaker shown and described in U.S. Pat. No. 4,341,062, issued Jul. 27, 1982. Foliage shakers such as depicted in the '062 patent are used on olive and tomato harvesters, and have a drive motor for driving an eccentric weight assembly. Apart from driving the foliage shaker in an oscillatory fashion about an oscillation axis, the drive motor creates a torque in the tine or brush assembly that causes the oscillating brush assembly or shaker head to accelerate in one rotational direction about the oscillation axis and ultimately to rotate out of control. The one rotational direction is in the same direction of rotation as that in which the eccentric weight assembly is driven. To counteract the tendency for the shaker head to rotate in one direction at motor drive speed a brake is used to brake the unidirectional rotation of the brush assembly in the shaker head. The braking action is applied on the shaker head oscillation axis. Coulomb friction is applied through the use of a band, drum or disc brake. Another approach is to use a viscous friction brake such as a hydraulic pump or motor connected to the shaker's center axle. A manually operated flow control valve located downstream from the drive motor is sometimes used to limit oil flow therethrough and to thus reduce rotation of the shaker head about the rotation axis. The drive motor may be a hydraulic pump or a hydraulic motor.

To this point there has been no “smart brake” capable of preventing the aforementioned uncontrolled rotation about the shaker head axis without reducing the necessary oscillation to obtain the function of the shaker head. When mechanical brakes are used, the braking friction generates heat and the brakes tend to fade upon heating and also to wear. When a viscous friction type brake utilizing a hydraulic pump or motor is used, braking characteristics tend to change as the hydraulic oil heats and changes viscosity. For a given friction brake setting, braking action is not as effective as shaker head oscillation speed or frequency increases. No means has been available to compensate for these undesirable characteristics. Further, if shaker net rotation at the tips of the shaker tines that penetrate the foliage of the crop is not synchronized within certain limits with the forward speed of the harvester, tree or foliage damage occurs. If the net rotation speed of the shaker is appreciably beyond those limits, faster or slower than the harvester forward ground speed, branches are broken, leaves are stripped, future crop yields are reduced and the harvester must separate extra trash from the harvested crop. Harvesters available previous to the instant invention have not effectively addressed these problems accompanying the use of an oscillatory force balance shaker head.

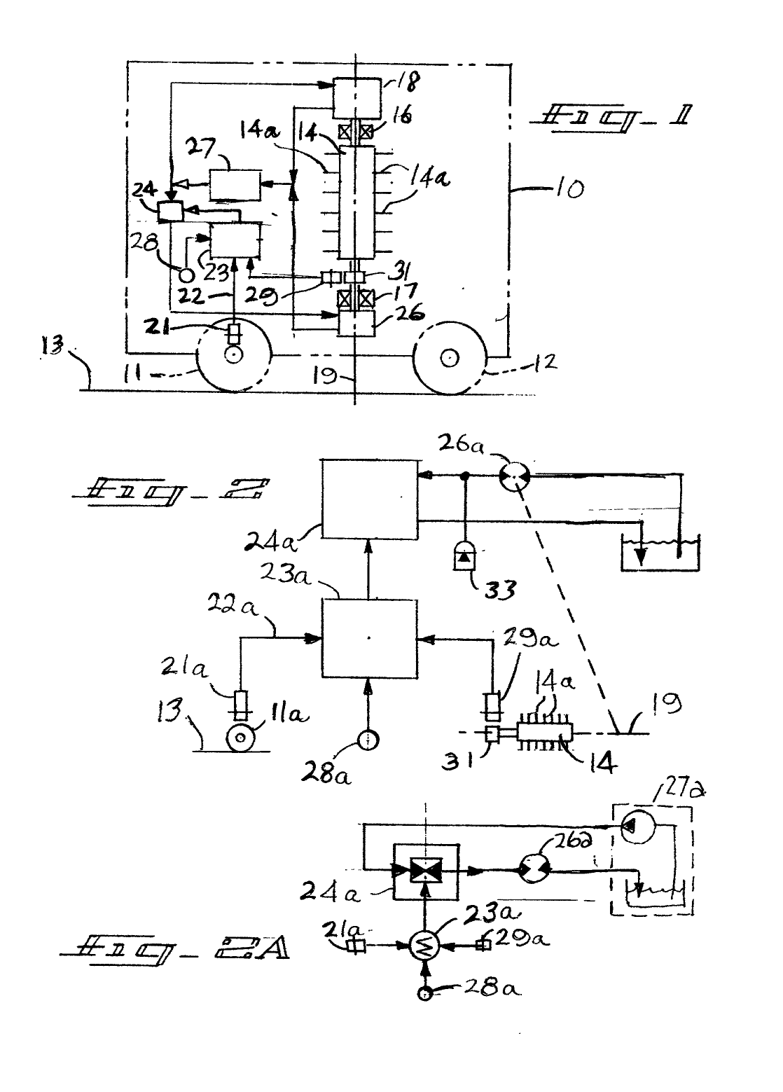

With reference now to FIG. 1 of the drawings, one embodiment of the invention disclosed herein will be described. The harvester 10 is shown in general outline in FIG. 1 supported by a pair of wheels 11 and 12 so that the harvester may be advanced along an underlying surface 13. A shaker head 14 is shown mounted in bearings 16 and 17 so that the shaker head is journaled for rotation within the framework of the crop harvester 10. A series of tines 14a is seen extending laterally from the shaker head 14 in FIG. 1, wherein the tines operate to penetrate the foliage of vines, bushes or trees carrying a crop to be harvested therefrom. Mounted also on the framework of the crop harvester 10 is a known force balance mechanism 18 having contra-rotating weights driven by a motor and found collectively in the item 18. As mentioned hereinbefore, the driver for the force balance assembly 18 that drives the shaker head 14 in an oscillatory manner about a shaker head axis 19 in FIG. 1 is disclosed in the '062 patent issued to Scudder in July, 1982. A ground speed sensor 21 is shown mounted adjacent an axle on which supporting wheel 11 is mounted to provide a signal indicative of vehicle forward velocity. The signal from sensor 21 is delivered through a line 22 to a controller 23. The controller 23 produces an output signal, which may be termed a shaker head control signal, that is connected to a metering device 24 as seen in FIG. 1. The shaker head control signal is termed a braking signal in one aspect of the invention and a torque-enhancing signal in another aspect of the invention. In general it is called an imposed torque signal in this description. A control torque element 26 is shown in FIG. 1 mounted on the axis of oscillation 19 of the shaker head 14. Connection is made between the control torque element 26 and the metering element 24 so that the metering element is situated in a path between the control torque element 26 and a power source 27. In FIG. 1 the metering element is situated upstream of the control torque element 26 for a purpose to be described herein. The power source 27 is utilized to drive the force balance mechanism 18 as well as, in the FIG. 1 embodiment, the control torque element 26. Power to the force balance mechanism 18 is not affected by the metering element because they are in parallel paths, as may be seen in FIG. 1. As a result, the torque imposed by element 26 on the oscillatory motion of the shaker head 14 about the oscillation axis 19 is controlled by the metering element 24 receiving the shaker head control signal from controller 23 so that the imposed torque is selectively controlled relative to the forward speed of the harvester 10 over the underlying surface 13.

In addition to the harvester ground speed input, an operator input is provided at a control point 28 in FIG. 1 for control 23. In this instance, the shaker head control signal output from control 23 is a combination of the harvester velocity signal from sensor 21 and the manual input at 28 provided by an operator of the harvester 10. The net rotation speed of the harvester shaker head 14 is then a function of harvester velocity and harvester operator input.

Continuing reference to FIG. 1 of the drawings shows a second speed sensor 29 mounted adjacent to a portion of a shaft 31 on the oscillation axis 19 of the shaker head 14. The speed sensor 29 functions to sense the speed of the shaft 31 about the axis 19. In a preferred embodiment, the speed or velocity sensors 29 and 21 provide a frequency output proportional to the sensed speed. In this fashion the speed sensor 29 is able to detect net rotation speed of the oscillatory shaker head 14 and the direction of the net speed about the oscillation axis 19. The speed of interest is the speed near the free ends of the tines 14a, the tangential tine tip speed. For example, a speed sensed providing ten pulses per second forward and eight pulses per second backward provides an indication of net angular rotation speed for the shaker head assembly 14 in the forward direction of two pulses per second. This of course is converted to tangential tine tip velocity to indicate the net velocity near the tine tips on the shaker head assembly. Consequently, when the controller 23 is set to provide a forward/backward signal difference of three pulses per second, the controller will adjust the signal to the metering element 24 to eliminate the one pulse per second error and provide a three pulses per second difference between the forward and the backward oscillatory rotational speeds sensed by the speed sensor 29.

It may be seen that the simplest embodiment, wherein only a ground speed signal from sensor 21 is connected to the control 23, allows the system to function open loop. The presumption here is that for a given metered amount of power from the power source 27 by the metering element 24 the shaker head assembly 14 will rotate at a known and repeatable speed. However, changing conditions, lumped herein within the term “uncontrolled operating conditions”, tend to change the rotational frequency and amplitude of the oscillatory shaker head assembly 14. The specific uncontrolled operating conditions will be discussed in conjunction with specific embodiments of the invention discussed hereinafter.

With regard to one specific embodiment of the present invention, attention is drawn to FIG. 2. Item numbers in FIG. 2 corresponding to items numbers described in conjunction with FIG. 1 will be assigned a suffix “a”. The ground speed signal for the harvester 10 is picked up adjacent a wheel 21a in FIG. 2 seen traversing the underlying surface or ground 13. Ground speed detector 21a transmits the ground speed signal through line 22a to controller 23a. The resultant shaker head control signal, called a braking signal in this embodiment, is connected to metering control 24a that is seen in FIG. 2 placed downstream in series with control torque element termed braking element 26a, which in this embodiment is a hydraulic motor or pump. Such a device may be driven by hydraulics as a motor or may be driven by mechanical input at its shaft and function as a hydraulic pump. Even though the device may work as both a motor and a pump, it will be designed to operate optimally as one or the other. A hydraulic motor primary design is preferred in this instance, because a motor allows more “slip” due to comparatively less efficient construction and greater internal leakage in the motor. The motor/pump braking element 26a in FIG. 2 is seen coupled to the oscillation axis 19 for shaker head assembly 14. The metering element 24a in FIG. 2 is a hydraulic flow control valve that allows a measured amount of oil to flow through it in accordance with the shaker head control output signal from controller 23a resulting from input of the ground speed control signal from sensor 21a. Motor/pump 26a, acting as a pump in this embodiment, has its pump output connected to the flow control valve 24a. Shaker rotation is thus controlled to correspond to harvester 10 ground speed by limiting flow through the hydraulic flow control 24a, and therefore pump net oscillatory speed, in accordance with the vehicle ground speed. The hydraulic open loop system is powered by the motor 26a acting as a hydraulic pump. When motor 26a acts as a pump, it is the power producing element in the isolated hydraulic system containing a hydraulic oil reservoir 30 in FIG. 2. As just described, the system functions adequately in theory without consideration of uncontrolled operating conditions, such as change in internal clearances in motor 26a due to temperature change or changes in the temperature of the hydraulic oil and the attendant viscosity in accordance with any particular temperature. Lower hydraulic oil viscosity from higher oil temperatures allows more internal motor slip in the hydraulic motor 26a, thereby affording increased rotational speed for the shaker head 14 as hydraulic oil temperature increases for a given setting in the hydraulic flow control valve 24a.

FIG. 2 also shows an operator input at 28a to the controller 23a that is combined with the ground speed signal from ground speed detector 21a to provide a shaker head control or braking signal output from the controller 23a connected to the hydraulic flow control valve 24a In this fashion, the operator has some control over the aforementioned change of speed of rotation about the shaker head assembly axis 19 due to temperature caused change in the hydraulic oil allowed to pass through the hydraulic motor 26a by the hydraulic flow control valve 24a or change in internal clearances in motor 26a An operator through the input 28a may therefore implement manual compensation.

Closure of the control loop is implemented in the embodiment of FIG. 2 by providing the speed sensor 29a described herein to detect the net speed of oscillatory motion about the oscillation axis 19 for the shaker head assembly 14. The signal generated by the speed sensor 29a is also connected to the controller 23a so that a difference between the ground speed signal from sensor 21a and the net shaker head oscillation speed signal obtained from the sensor 29a is held to a particular value by the controller 23a as it is selected at the operator input 28a. As explained hereinbefore, if the difference is three cycles per second (both sensor signals being in form of frequency outputs proportional to speed), a variation from the three cycle setting will be corrected by speeding up or slowing down the braking element represented by the hydraulic motor 26a in FIG. 2. There may be instances where it is desirable to control the tine 14a tip speed to be greater than or less than the forward speed of the harvester 10 over the underlying surface 13. Desirable characteristics such as net tine tip speed rotation being equal to, greater than or less than the harvester forward ground speed are dependent upon the type of crop being harvested and the characteristics of the foliage carrying that crop.

Accumulators 33 and 34 are seen in FIG. 2 that tend to facilitate oscillation in the shaker head 14 without relying on slip within the motor 26a. This feature is installed to reduce heat generated by motor slip as well as to reduce hydraulic motor wear and to afford increase in oscillation amplitudes where desirable, in the shaker head assembly 14.

Another uncontrolled operating condition exists within the flow control valve 24a A flow control valve 24a that operates well in a preferred embodiment is an electronically adjustable proportional pressure compensated valve, that is a two port, five gallon per minute valve provided by J. B. Rand Hydraulics of Omaha, Nebraska. The valve is shown m FIG. 2A functioning in series with the hydraulic motor 26a. As in FIG. 2, the valve 24a receives a shaker head control signal 25a, termed the “braking signal” in the embodiment of FIG. 2, but better called the imposed torque signal in the embodiment of FIG. 2A as discussed previously. The imposed torque signal is produced by the controller 23a upon reception and combination of the harvester velocity signal from sensor 21a and either or both of the operator control signal from point 28a and the shaker head assembly 14 net rotational speed signal from sensor 29a. A distinction between the systems of FIGS. 2 and 2A is noted wherein the flow control valve 24a is now upstream of the motor pump 26a and a hydraulic power source 27a has a pressure side connected to an input on the flow control valve. The flow control valve output is now connected to the input side of the motor 26a in FIG. 2A and is able to drive the motor to produce tine tip speeds higher than harvester ground speed if required. The hydraulic path containing the flow control valve is parallel to the path containing the force balance mechanism 18. The system of FIG. 2A compensates for all errors contributed by system components including those from oil viscosity changes that increase slip in the braking motor 26a as well as inaccuracies in the flow control valve 24a. As a result, rotation of the shaker head assembly 14 is adjustable to be proportional to the ground speed of the harvester 10. Moreover, net rotation speed of the oscillating shaker head assembly 14 is adjustable to assume a speed at the portions of the shaker tines within the crop foliage anywhere within the range of 90 percent to 110 percent of harvester ground speed according to the requirements of the crop being harvested. When the net tine tip speed or net rotational speed of the shaker head is referenced relative to the forward ground speed of the harvester 10, the referenced speed is the net speed of the shaker head assembly tines within the crop being harvested.

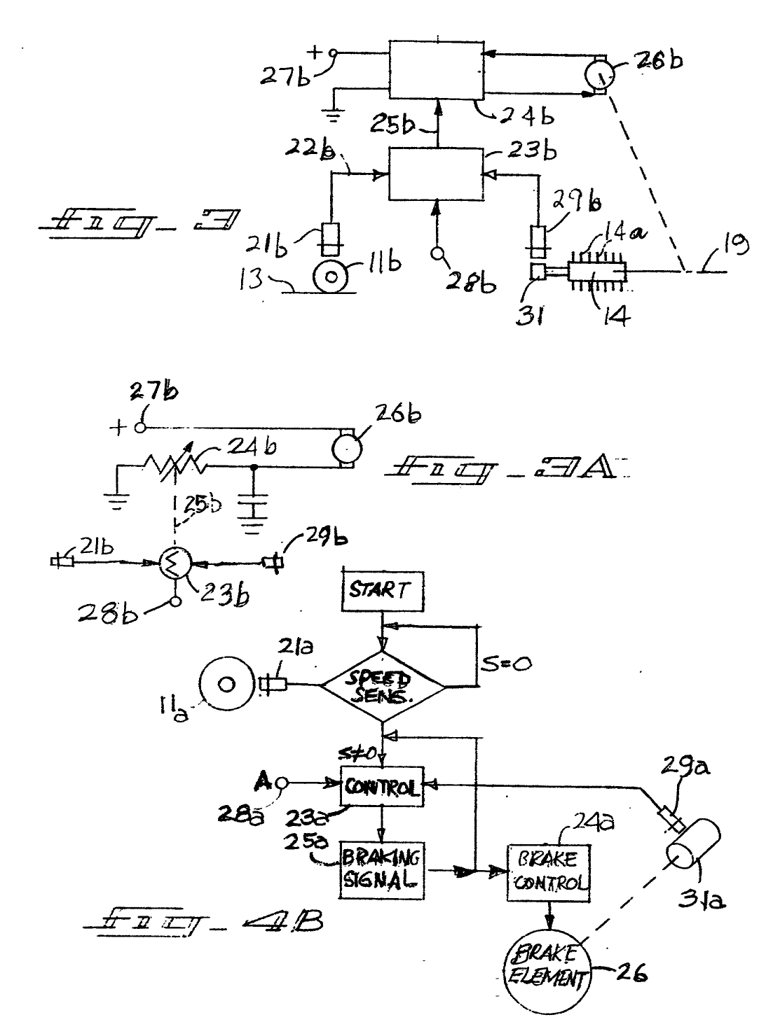

FIG. 3 shows a system wherein the advantages of the invention disclosed herein are obtained using electrically powered components and a suitable electrical speed control. A “b” will be used in FIG. 3 to designate similar functional elements described in conjunction with FIG. 1 that appear in the electrical system of FIG. 3. A metering element 24b in FIG. 3 is shown in FIG. 3A as a rheostat 24b connected between an electrical power supply 27b and an electric motor/generator 26b. The motor/generator is connected to the oscillatory axis 19 as shown for providing an imposed torque, which will be termed a braking action to the oscillation of the shaker head assembly 14 in the embodiment of FIG. 3A. A vehicle speed pickup 21b as described hereinbefore is delivered through a line 22b to a controller 23b. The controller 23b provides a braking output signal 25b connected to the metering element 23b, in this instance the aforementioned rheostat, as seen in FIG. 3A. As a result an open loop system is provided for a harvester 10 that controls the rotational speed of the shaker head assembly 14 to correspond to the forward velocity of the harvester 10 over the underlying surface 13. This open loop system suffers from similar deficiencies caused by uncontrolled operating conditions, as does the open loop system discussed in conjunction with the description of FIG. 2.

FIG. 3 also shows an operator input 28b connected to the controller 23b. The operator control input is combined with the harvester velocity input from speed sensor 21b to provide a braking signal output 25b from the controller 23b to adjust the electrical metering element 24b to provide the desired power to the motor/generator 26b. In this fashion, the electrical system described thus far has the ability to provide a net speed on the portions of the tines 14a within the crop foliage that is proportional to the forward velocity of the harvester 10 plus or minus an adjustable amount inputted by an operator at the point 28b. The system thus far described is still open loop and subject to uncontrolled operating conditions as described hereinbefore.

FIGS. 3 and 3A also show a speed sensor 29b providing the shaker head speed signal discussed hereinbefore as an additional input to the controller 23b. The signals from sensors 21b and 29b together with the operator input signal from 28b are combined within the controller 23b to provide the braking output signal 25b connected to electrical metering device 24b. In this instance, the rheostat 24b seen in FIG. 3A represents electrical metering device 24b. Electrical metering device 24b therefore provides power to motor generator 26b sufficient to control net rotation speed of the tines within the crop foliage that is dependent on the forward velocity of the harvester 10 and is corrected by the net rotation speed sensed at the shaker head assembly 14. Net tine tip velocity is therefore controlled in accordance with the greater or lesser comparative velocities selected by the operator through the point 28b. The system of FIG. 3 therefore is able to adjust the net rotation of the shaker head assembly tines 14a so that the net rotation speed is set at a selected proportion of the ground speed of the harvester 10. Further, the closed loop embodiment of the system of FIG. 3 containing the speed sensor 29b has the capability of maintaining a ratio between harvester ground speed and net tine rotation speed within a predetermined range as determined by an operator of the harvester.

FIG. 3B depicts the electrical embodiment of the present invention that corresponds somewhat to the hydraulic embodiment of FIG. 2A. The arrangement of FIG. 3B is similar to that of FIG. 3A, but illustrates conditions wherein a higher potential is available from rheostat 24b for application to the terminals of motor/generator 26b than was available in the embodiment of FIG. 3A. The function of the embodiment of FIG. 3B is to afford adjustment of the shaker head control signal to obtain tine 14a tip net velocities of from 90% to as high as 110% of harvester ground velocity. As in the embodiment of FIG. 2A, the signal 25b of FIG. 3B is called an imposed torque signal.

Turning now to FIG. 4A of the drawings, the method of the present invention will be described. The method relates to controlling net rotation speed of an oscillating shaker head in a crop harvester that is used for dislodging crops from crop foliage. The net rotation of the shaker head and the speed thereof is produced about an oscillation axis by an oscillatory driving mechanism for the shaker head as previously described. The harvester is moved at a controlled speed past the crop foliage and proximate thereto. At the start of the process, a speed for the harvester is sensed by the aforementioned magnetic pickup type speed sensor 21 positioned adjacent one of the harvester wheels (item 11 in FIG. 4A). The sensed harvester speed is continually scanned and sent to a control 23 where it is converted into a head control signal 25. The head control signal is applied to a torque control, item 24, termed a metering element in FIG. 1, that is used to urge a predetermined torque application about the oscillation axis 19 through the control torque element 26, described hereinbefore. In this fashion net rotation speed of the oscillating shaker head is controlled relative to a controlled harvester speed.

The method described in conjunction with FIG. 4A also includes an operator-controlled input at 28, corresponding to the input 28 in FIG. 1. The operator input is combined in the controller 23 with the speed sensed signal from sensor 21 and provided as an output from the controller 23, seen in FIG. 4A as the head control signal 25. In this fashion, while the system is yet operating open loop, the operator is able to exercise some control over the relationship between the net rotation speed of the tines on the shaker head assembly 14 and the forward speed of the harvester 10. Uncontrolled operating conditions may cause the operator to find it necessary to occasionally readjust operator input 28 to maintain the desirable relationship between harvester forward speed and shaker head net rotational speed.

Further, in accordance with the diagram of FIG. 4A it is seen that the speed sensor 29 described in conjunction with FIG. 1 is present. The method includes the step of sensing the net rotation speed of the oscillating shaker head and providing a corresponding net rotation speed indicative signal to the control 23. The harvester forward velocity signal, the operator input signal and the sensed net rotation speed of the oscillating shaker head signal are combined in control 23 to provide the head control signal 25. The head control signal 25 is applied to metering or torque control 24 to provide torque control to the control torque element 26 to close the loop and maintain the harvester forward speed and the net rotational speed of the shaker head assembly in a desired predetermined relationship. As mentioned hereinbefore, the control torque element 26 may either be driven externally at a shaft or internally as a motor to fit the circumstances for maintaining control of the shaker head net rotational velocity. FIGS. 2, 2A, 4A and 4B provide examples of the manner in which these methods are practiced.

As seen in FIG. 4B, a more specific embodiment of the method of the present invention is described. Item numbers in FIG. 4B are assigned numbers corresponding to those appearing in FIG. 2. As with the method described in conjunction with FIG. 4A, at the start of the process a speed of the harvester 10 is sensed by an aforementioned magnetic pickup type speed sensor 21a positioned adjacent one of the harvester wheels 11a. The sensed harvester speed is continually scanned and sent to a control position 23a where it is converted into a braking signal 25a. The braking signal is applied to a brake control, item 24a, termed a metering element in FIG. 1, that is used to urge a braking action about the oscillation axis 19 through a braking element 26a, described hereinbefore. In this fashion net rotation speed of the oscillating shaker head is controlled relative to a controlled harvester speed.

The method described in conjunction with FIG. 4B also includes an operator-controlled input 28a in FIG. 4B, corresponding to the input point 28 in FIG. 1. The operator input is combined in the controller 23a with the speed sensed signal from sensor 21a and provided as an output from the controller 23a, seen in FIG. 4B as the braking signal 25a. In this fashion, while the system is yet operating open loop, the operator is able to exercise some control over the relationship between the net rotation speed of the tines on the shaker head assembly 14 and the forward speed of the harvester 10. Uncontrolled operating conditions may cause the operator to find it necessary to occasionally readjust operator input to maintain the desirable relationship between harvester forward speed and shaker head rotational speed.

Further, in accordance with the diagram of FIG. 4B it is seen that a speed sensor 29a similar to that described in conjunction with FIG. 1 is present. The method includes the step of sensing the net rotation speed of the oscillating shaker head and providing a corresponding net rotation speed indicative signal to the control 23a. The harvester forward velocity signal, the operator input signal and the sensed net rotation speed of the oscillating shaker head signal are combined in control 23a to provide the braking signal 25a. The braking signal 25a is applied to metering control or brake control 24a to provide braking to the brake element 26a to close the loop and maintain the harvester forward speed and the net rotational speed of the shaker head assembly in the predetermined relationship.

FIG. 5 illustrates one set of operating conditions for the present invention. The Figure shows crop foliage 36 wherein an oscillating shaker head 14 has a tip on tine 14a engaging the foliage. An arrow 37 indicates the direction of travel of the harvester 10 that has the oscillatory shaker head 14 mounted therein as previously described. In FIG. 5 one unbalance weight 38 of a pair of such weights in the known force balance mechanism 18 is shown rotating in a counter clockwise sense. This produces a counter clockwise torque about shaker axis 19 resulting in net oscillating shaker angular velocity indicated by arrow 39. A drag torque induced by foliage 36 for the indicated velocity 37 of the harvester has the same sense as angular velocity 39. In the embodiment of FIG. 2, for example, when circumstances are as described for FIG. 5 and control torque is imposed only by pump 26a, the shaker head may not be able to drive the pump to produce sufficient power to obtain tine 14a tip velocity of 110% of harvester speed even when the flow control valve 24a is fully open. Additionally, in the example, where it is desirable to obtain a tine 14a tip velocity of 90% of harvester velocity in the direction of arrow 37, the cumulative torque from crop drag and from rotation of weight 38 may be too great to maintain net rotation velocity control even when the flow control valve 24a is fully closed. This occurs because of internal “slip” due to leakage in pump/motor 26a.

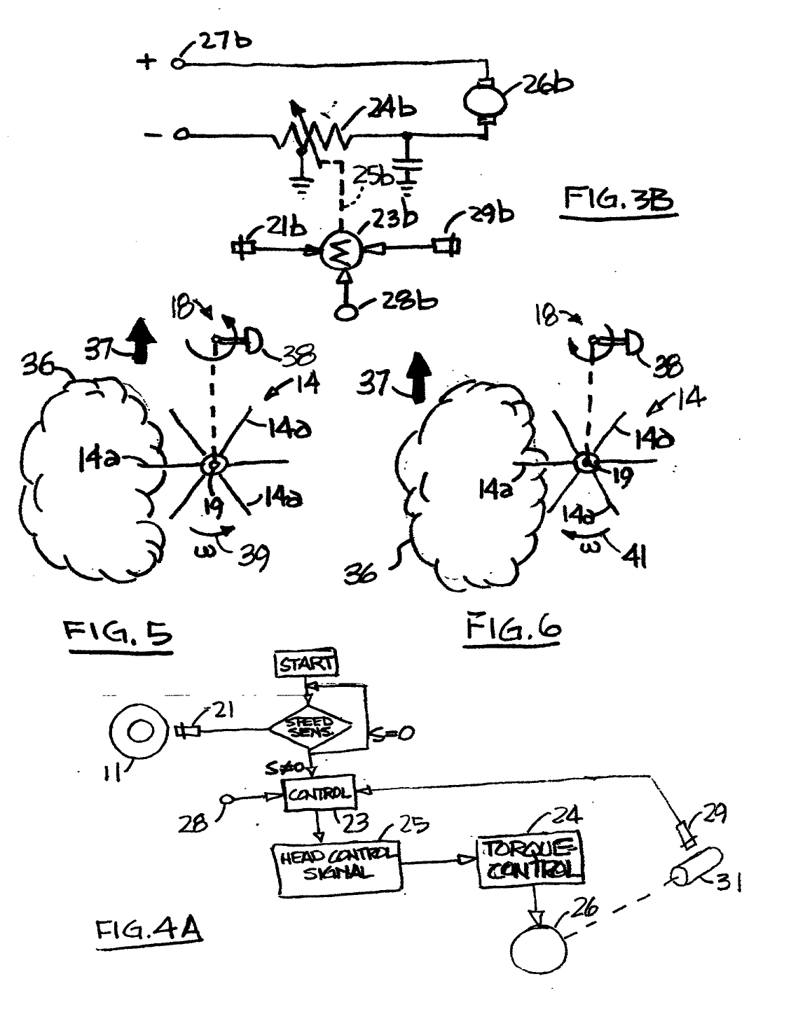

FIG. 6 shows a solution for the foregoing control maintenance problem. Foliage 36 appears in FIG. 6 and an oscillatory shaker head 14 is shown driven by force balance mechanism 18 having weights, one shown at 38 in FIG. 6, rotating in a clockwise direction. This produces a clockwise torque about shaker axis 19 resulting in net oscillating shaker angular velocity indicated by arrow 41. This clockwise torque is opposed by crop drag torque due to harvester 10 velocity 37 as indicated in FIG. 6. In the embodiment of FIG. 2A, torque is imposed by element 26a acting as a motor driven by outside hydraulic power source 27a metered by flow control valve 24a. In this instance, if it is desirable to set net tine 14a rotation velocity so the tine tip travels at 110% of harvester velocity, hydraulic power metered through valve 24a to motor 26a is more likely to be capable of maintaining net shaker velocity control. When net shaker velocity is set to produce tine 14a tip velocity of 90% of harvester velocity, flow control valve 24a can meter enough power to motor 26a to maintain control of net shaker velocity unless crop drag torque becomes greater than the clockwise imposed rotation torque. When this happens, the motor 26a reverts to being a pump. Properly sized elements in the embodiments of FIGS. 2 and 2A will avoid these difficulties, but the embodiment of FIG. 2A possesses the disclosed advantages.

Although the best mode contemplated for carrying out the present invention has been shown and described herein, it will be understood that modification and variation may be made without departing from what is regarded to be the subject matter of the invention.

What is claimed:

1. Apparatus for controlling net rotation speed of an oscillating shaker head produced by an oscillatory driver operating to drive the shaker head about an oscillation axis for contacting foliage of vines, bushes and trees to dislodge crops therefrom, wherein the oscillating shaker head is mounted on a mobile vehicle for moving at a controlled speed past and proximate to the vines, bushes and trees, comprising
means for sensing the controlled speed of the mobile vehicle, said means for sensing providing a vehicle speed proportional signal,
means for receiving said vehicle speed proportional signal and for providing a shaker head control signal, and means for receiving said shaker head control signal and for providing a predetermined control torque about the oscillation axis, whereby net rotation speed of the oscillating shaker head is controlled relative to the controlled speed of the mobile vehicle.

2. The apparatus of claim 1, comprising
means for providing an operator control signal connected to said means for receiving said vehicle speed proportional signal, said operator control signal being combined with said vehicle speed proportional signal for controlling said shaker head control signal and said predetermined control torque.

3. The apparatus of claim 2, wherein net rotation speed is subject to change due to uncontrolled operating conditions, comprising
means for sensing net rotation speed of the oscillating shaker head and for providing a net rotation speed output signal, said net rotation speed output signal being connected to said means for receiving said vehicle speed proportional signal, whereby said shaker head control signal is adjusted for changes in said means for providing a predetermined control torque due to uncontrolled operating conditions.

4. The apparatus of claim 1, wherein said means for receiving said shaker head control signal and for providing predetermined control torque, comprises
a hydraulic motor for providing said predetermined control torque, and
a hydraulic flow control means connected in series with said hydraulic motor for receiving said shaker head control signal.

5. The apparatus of claim 1, wherein said means for receiving said shaker head control signal and for providing predetermined control torque, comprises
an electric motor/generator for providing said predetermined control torque, and
a current control means connected to said electric motor/generator for receiving said shaker head control signal.

6. The apparatus of claim 2, wherein said means for receiving said shaker head control signal and for providing predetermined control torque, comprises
a hydraulic motor for providing said predetermined control torque, and
a hydraulic flow control means connected in series with said hydraulic motor for receiving said shaker head control signal.

7. The apparatus of claim 2, wherein said means for receiving said shaker head control signal and for providing predetermined control torque, comprises
an electric motor/generator for providing said predetermined control torque, and
a current control means connected to said electric motor/generator for receiving said shaker head control signal.

8. The apparatus of claim 3, wherein said means for receiving said shaker head control signal and for providing predetermined control torque, comprises
a hydraulic motor for providing said predetermined control torque, and
a hydraulic flow control means connected in series with said hydraulic motor for receiving said shaker head control signal.

9. The apparatus of claim 3, wherein said means for receiving said shaker head control signal and for providing predetermined control torque, comprises
an electric motor/generator for providing said predetermined control torque, and
a current control means connected to said electric motor/generator for receiving said shaker head control signal.

10. The apparatus of claim 4, comprising
an accumulator in communication with said hydraulic motor.

11. The apparatus of claim 6, comprising
an accumulator in communication with said hydraulic motor.

12. The apparatus of claim 8, comprising
an accumulator in communication with said hydraulic motor.

13. The apparatus of claim 8, wherein a hydraulic power source having a high pressure output is connected to said hydraulic motor, said hydraulic flow control means being connected between said high pressure output and said hydraulic motor whereby additional positive hydraulic pressure is metered to said hydraulic motor through said hydraulic flow control means, so that additional net rotation speed is attainable.

14. Apparatus for controlling net rotation speed of an oscillating shaker head produced by an oscillatory driver operating to drive the shaker head about an oscillation axis for contacting foliage of vines, bushes and trees to dislodge crops therefrom, wherein the oscillating shaker head is mounted on a mobile vehicle for moving at a controlled speed past and proximate to the vines, bushes and trees, comprising
means for sensing the controlled speed of the mobile vehicle, said means for sensing providing a vehicle speed proportional signal,
means for receiving said vehicle speed proportional signal and for providing a braking signal, and
means for receiving said braking signal and for providing braking resistance about the oscillation axis, whereby net rotation speed of the oscillating shaker head is controlled relative to the controlled speed of the mobile vehicle.

15. The apparatus of claim 14, comprising
means for providing an operator control signal connected to said means for receiving said vehicle speed proportional signal, said operator control signal being combined with said vehicle speed proportional signal for controlling said braking signal and said braking resistance.

16. The apparatus of claim 15, wherein net rotation speed is subject to change due to uncontrolled operating conditions, comprising
means for sensing net rotation speed of the oscillating shaker head and for providing a net rotation speed output signal, said net rotation speed output signal being connected to said means for receiving said vehicle speed proportional signal, whereby said braking signal is adjusted for changes in said means for providing braking resistance due to uncontrolled operating conditions.

17. The apparatus of claim 14, wherein said means for receiving said braking signal and for providing braking resistance, comprises
a hydraulic motor for providing said braking resistance, and
a hydraulic flow control means connected in series with said hydraulic motor for receiving said braking signal.

18. The apparatus of claim 14, wherein said means for receiving said braking signal and for providing braking resistance, comprises
an electric motor/generator for providing braking resistance, and
a current control means connected to said electric motor/generator for receiving said braking signal.

19. The apparatus of claim 15, wherein said means for receiving said braking signal and for providing braking resistance, comprises
a hydraulic motor for providing braking resistance, and
a hydraulic flow control means connected in series with said hydraulic motor for receiving said braking signal.

20. The apparatus of claim 15, wherein said means for receiving said braking signal and for providing braking resistance, comprises
an electric motor/generator for providing braking resistance, and
a current control means connected to said electric motor/generator for receiving said braking signal.

21. The apparatus of claim 16, wherein said means for receiving said braking signal and for providing braking resistance, comprises
a hydraulic motor for providing braking resistance, and
a hydraulic flow control means connected in series with said hydraulic motor for receiving said braking signal.

22. The apparatus of claim 16, wherein said means for receiving said braking signal and for providing braking resistance, comprises
an electric motor/generator for providing braking resistance, and
a current control means connected to said electric motor/generator for receiving said braking signal.

23. The apparatus of claim 17, comprising
an accumulator in communication with said hydraulic motor.

24. The apparatus of claim 19, comprising
an accumulator in communication with said hydraulic motor.

25. The apparatus of claim 21, comprising
an accumulator in communication with said hydraulic motor.

26. The apparatus of claim 21, wherein a hydraulic power source has a high pressure output connected to said hydraulic flow control means, said hydraulic flow control means having a metered output connected to said hydraulic motor, whereby an additional positive hydraulic pressure is provided to said hydraulic motor for enhancing net rotation speed.

27. A harvesting vehicle for moving over an underlying surface at a controlled speed and for carrying a force balance crop shaker having a drive mechanism connected to drive a shaker drum assembly in an oscillatory manner about a rotation axis, the drive mechanism operating to drive the shaker drum assembly to produce a net shaker drum rotation speed, wherein the shaker drum assembly operates to engage foliage on a crop for dislodging the crop therefrom, comprising
a speed sensor on the harvesting vehicle for sensing the controlled speed and for providing a vehicle speed indicative signal,
means for providing an operator control signal,
control means for receiving said vehicle speed indicative signal and said operator control signal and for providing a braking signal output, and
means for receiving said braking signal and for providing an operator controlled braking action for shaker drum assembly rotation about the rotation axis, whereby net shaker drum rotation speed is operator controlled relative to the harvesting vehicle controlled speed.

28. The harvesting vehicle of claim 27, wherein net shaker drum rotation speed is subject to change due to uncontrolled operating conditions, comprising
means for sensing net rotation speed of the shaker drum assembly and for providing a net rotation speed output signal connected to said control means, whereby said braking signal is adjusted for uncontrolled operating conditions.

29. The harvesting vehicle of claim 27, wherein said means for receiving said braking signal and for providing operator controlled braking action, comprises
a hydraulic motor for providing said operator controlled braking action, and
a hydraulic flow control for receiving said braking signal.

30. The harvesting vehicle of claim 27, wherein said means for receiving said braking signal and for providing operator controlled braking action, comprises
an electric motor/generator for providing operator controlled braking action, and
a current control means for receiving said braking signal.

31. The harvesting vehicle of claim 28, wherein said means for receiving said braking signal and for providing operator controlled braking action, comprises
a hydraulic motor for providing said operator controlled braking action, and
a hydraulic flow control for receiving said braking signal.

32. The harvesting vehicle of claim 28, wherein said means for receiving said braking signal and for providing operator controlled braking action, comprises
an electric motor/generator for providing operator controlled braking action, and
a current control means for receiving said braking signal.

33. The harvesting vehicle of claim 29, comprising
means for providing an additional positive hydraulic pressure to said hydraulic motor, so that additional net rotation speed is attainable.

34. The harvesting vehicle of claim 29, comprising
an accumulator in communication with said hydraulic motor.

35. The harvesting vehicle of claim 29, comprising
an accumulator in communication with said hydraulic motor.

36. A method of controlling net rotation speed of an oscillating shaker head in a crop harvester for dislodging crops from crop foliage, wherein the net rotation speed is produced about an oscillation axis by an oscillatory driving mechanism for the shaker head, and the harvester is moved at a controlled speed past and proximate to the crop foliage, comprising the steps of
sensing the speed of the crop harvester and providing a vehicle speed indicative signal,
converting the vehicle speed indicative signal into a corresponding shaker head control signal, and
applying torque about the oscillation axis corresponding to the shaker head control signal, whereby net rotation speed of the oscillating shaker head is controlled relative to the harvester controlled speed.

37. The method of claim 36, comprising the steps of
providing an operator control signal, and
combining the operator control signal with the vehicle speed indicative signal to thereby introduce operator control into the corresponding shaker head control signal.

38. The method of claim 37, wherein net rotation speed is subject to change due to uncontrolled operating conditions, comprising the steps of
sensing the net rotation speed of the oscillating shaker head and providing a net rotation speed indicative signal, and
combining the net rotation speed indicative signal with the combined operator control and vehicle speed indicative signals, to thereby adjust the corresponding shaker head control signal to compensate for uncontrolled operating conditions.

39. The method of claim 38, comprising the step of
assisting the oscillatory driving mechanism for the shaker head whereby the net rotation speed of the oscillatory shaker head is enhanced.

40. A method of controlling net rotation speed of an oscillating shaker head in a crop harvester for dislodging crops from crop foliage, wherein the net rotation speed is produced about an oscillation axis by an oscillatory driving mechanism for the shaker bead, and the harvester is moved at a controlled speed past and proximate to the crop foliage, comprising the steps of
sensing the speed of the crop harvester and providing a vehicle speed indicative signal,
converting the vehicle speed indicative signal into a corresponding braking signal, and
applying braking action about the oscillation axis, corresponding to the braking signal, whereby net rotation speed of the oscillating shaker head is controlled relative to the harvester controlled speed.

41. The method of claim 40, comprising the steps of
providing an operator control signal, and
combining the operator control signal with the vehicle speed indicative signal to thereby introduce operator control into the corresponding braking signal.

42. The method of claim 41, wherein net rotation speed is subject to change due to uncontrolled operating conditions, comprising the steps of
sensing the net rotation speed of the oscillating shaker head and providing a net rotation speed indicative signal, and
combining the net rotation speed indicative signal with the combined operator control and vehicle speed indicative signals, to thereby adjust the corresponding braking signal to compensate for uncontrolled operating conditions.

43. The method of claim 42, comprising the step of
assisting the oscillatory driving mechanism for the shaker head whereby the net rotation speed of the oscillatory shaker head is enhanced.
